(19) United States
(12) Patent Application Publication
(10) Pub. No.: US 2023/0105071 A1
(43) Pub. Date: Apr. 6, 2023

(54) AIR ADJUSTING DEVICE AND ORGANISM CARE SYSTEM

(71) Applicant: Wistron Corporation, New Taipei City (TW)

(72) Inventors: Long-Jhe Yan, New Taipei City (TW); Yung-Yu Chen, New Taipei City (TW); Hung-Li Chen, New Taipei City (TW)

(73) Assignee: Wistron Corporation, New Taipei City (TW)

(21) Appl. No.: 17/551,188

(22) Filed: Dec. 15, 2021

(30) Foreign Application Priority Data
Oct. 6, 2021 (TW) 110137130

(51) Int. Cl. A61G 10/04; A61G 10/00; A61G 10/02

(52) U.S. Cl. CPC A61G 10/04; A61G 10/02; A61G 10/005; F24F 11/0001

(57) ABSTRACT

An air adjusting device includes a casing, a hood, a first airflow generating unit, a tunnel and an air conditioning module. The hood has a wind inlet. The first airflow generating unit is connected to the hood. The tunnel is connected to the first airflow generating unit, wherein the tunnel has a wind outlet. The hood, the first airflow generating unit and the tunnel form an airflow passage. The airflow passage is isolated from an internal space of the casing. At least one part of the air conditioning module is disposed at the wind inlet. The first airflow generating unit draws a first ambient air into the airflow passage from the wind inlet. A temperature of the first ambient air is adjusted by the air conditioning module and discharged from the wind outlet through the airflow passage.

### BACKGROUND OF THE DISCLOSURE

### 1. Field of the Disclosure

The disclosure relates to an air adjusting device and, more particularly, to an air adjusting device capable of maintaining an oxygen concentration inside an enclosed chamber and an organism care system equipped with the air adjusting device.

### 2. Description of the Prior Art

At present, more and more people regard pets as important members of their families. When a pet is injured or sick, people hope that the pet can be well taken care of. Thus, the development of pet intensive care unit (ICU) is also receiving more and more attention. In general, the pet ICU will control the temperature and humidity in an appropriate state and will supply oxygen to the pet in need. However, an air conditioning system of the pet ICU of the prior art is not isolated from the outside, i.e. the inside of the pet ICU will exchange air with the outside, such that oxygen cannot be maintained at a specific concentration. Accordingly, the pet cannot be well taken care of.

### SUMMARY OF THE DISCLOSURE

The disclosure provides an air adjusting device capable of maintaining an oxygen concentration inside an enclosed chamber and an organism care system equipped with the air adjusting device, so as to solve the aforesaid problems.

According to an embodiment of the disclosure, an air adjusting device comprises a casing, a hood, a first airflow generating unit, a tunnel and an air conditioning module. The hood is disposed in the casing and the hood has a wind inlet. The first airflow generating unit is disposed in the casing and connected to the hood. The tunnel is disposed in the casing and connected to the first airflow generating unit, wherein the tunnel has a wind outlet. The hood, the first airflow generating unit and the tunnel form an airflow passage. The airflow passage is isolated from an internal space of the casing. At least one part of the air conditioning module is disposed at the wind inlet. The first airflow generating unit draws a first ambient air into the airflow passage from the wind inlet. A temperature of the first ambient air is adjusted by the air conditioning module and discharged from the wind outlet through the airflow passage.

According to another embodiment of the disclosure, an organism care system comprises an enclosed chamber and an air adjusting device. The air adjusting device comprises a casing, a hood, a first airflow generating unit, a tunnel and an air conditioning module. The casing is disposed on the enclosed chamber. The hood is disposed in the casing and the hood has a wind inlet, wherein the wind inlet is located inside the enclosed chamber. The first airflow generating unit is disposed in the casing and connected to the hood. The tunnel is disposed in the casing and connected to the first airflow generating unit, wherein the tunnel has a wind outlet and the wind outlet is located inside the enclosed chamber. The hood, the first airflow generating unit and the tunnel form an airflow passage . The airflow passage is isolated from an internal space of the casing. At least one part of the air conditioning module is disposed at the wind inlet. The first airflow generating unit draws a first ambient air inside the enclosed chamber into the airflow passage from the wind inlet. A temperature of the first ambient air is adjusted by the air conditioning module and discharged to the inside of the enclosed chamber from the wind outlet through the airflow passage.

As mentioned in the above, since the airflow passage formed by the hood, the first airflow generating unit and the tunnel is isolated from the internal space of the casing, the inside of the enclosed chamber equipped with the air adjusting device is isolated from the outside. That is to say, the inside of the enclosed chamber will not exchange air with the outside. Accordingly, the oxygen inside the enclosed chamber can be maintained at a specific concentration, such that an organism accommodated inside the enclosed chamber can be well taken care of.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating an organism care system according to an embodiment of the disclosure.

FIG. 2 is a perspective view illustrating the organism care system shown in FIG. 1 from another viewing angle.

FIG. 3 is a perspective view illustrating the organism care system shown in FIG. 1 from another viewing angle.

FIG. 4 is a perspective view illustrating an air adjusting device shown in FIG. 1 from another viewing angle.

FIG. 5 is a perspective view illustrating the inside of the air adjusting device shown in FIG. 1 from another viewing angle.

FIG. 6 is a perspective view illustrating the air adjusting device shown in FIG. 5 from another viewing angle.

FIG. 7 is a partial perspective view illustrating the air adjusting device shown in FIG. 5 from another viewing angle.

FIG. 8 is a sectional view illustrating the organism care system shown in FIG. 1.

FIG. 9 is a partial sectional view illustrating the organism care system shown in FIG. 1.

FIG. 10 is a schematic view illustrating the air adjusting device shown in FIG. 1 communicating with an electronic device.

### DETAILED DESCRIPTION

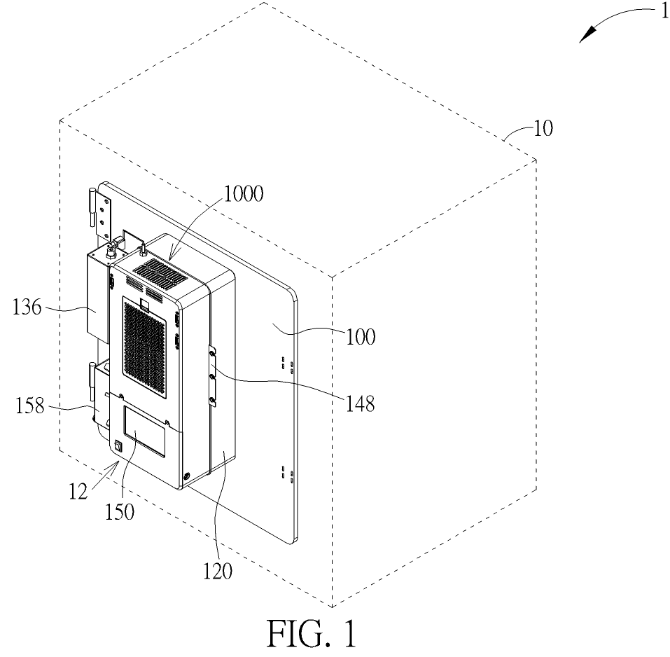

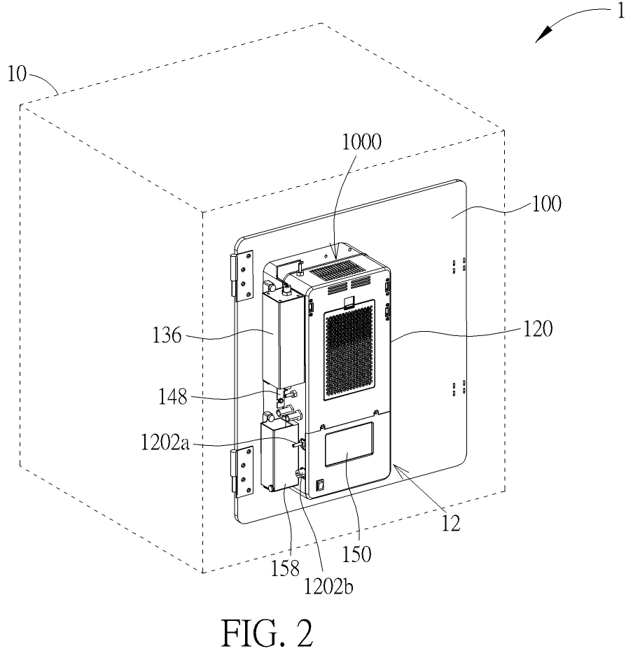

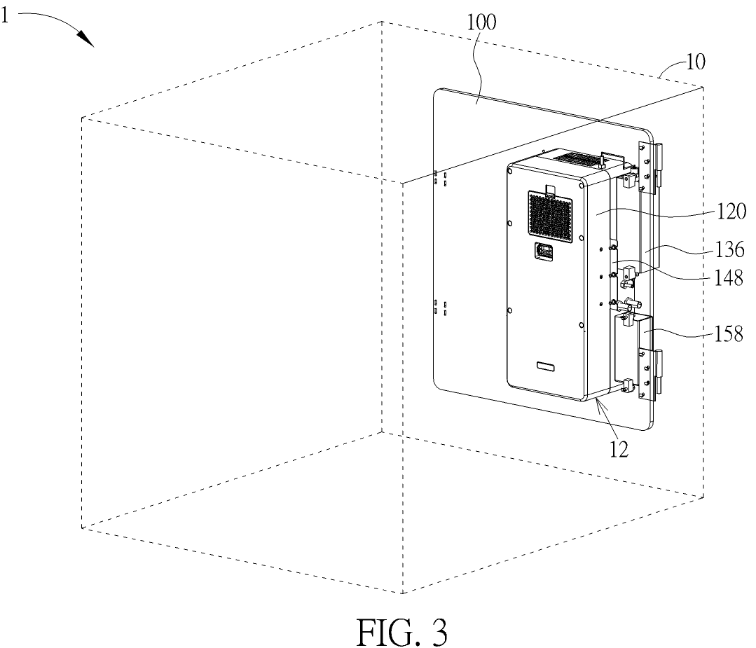

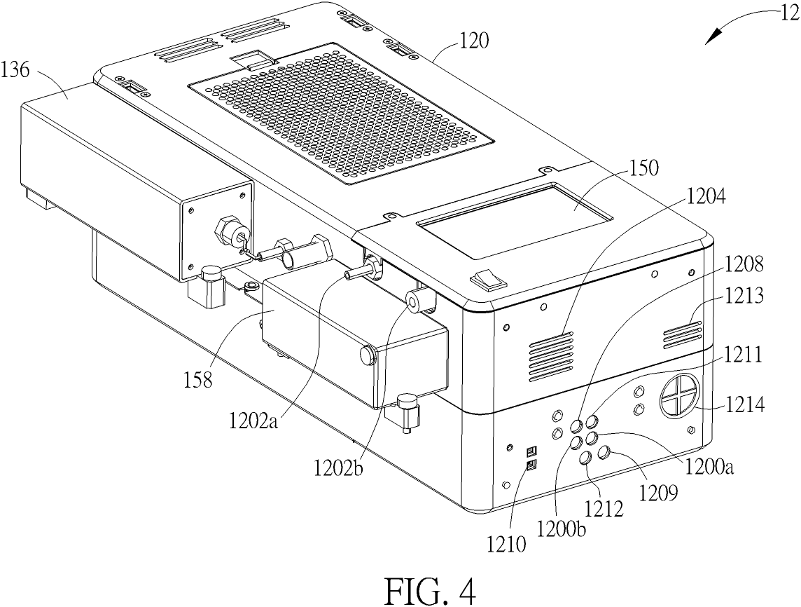

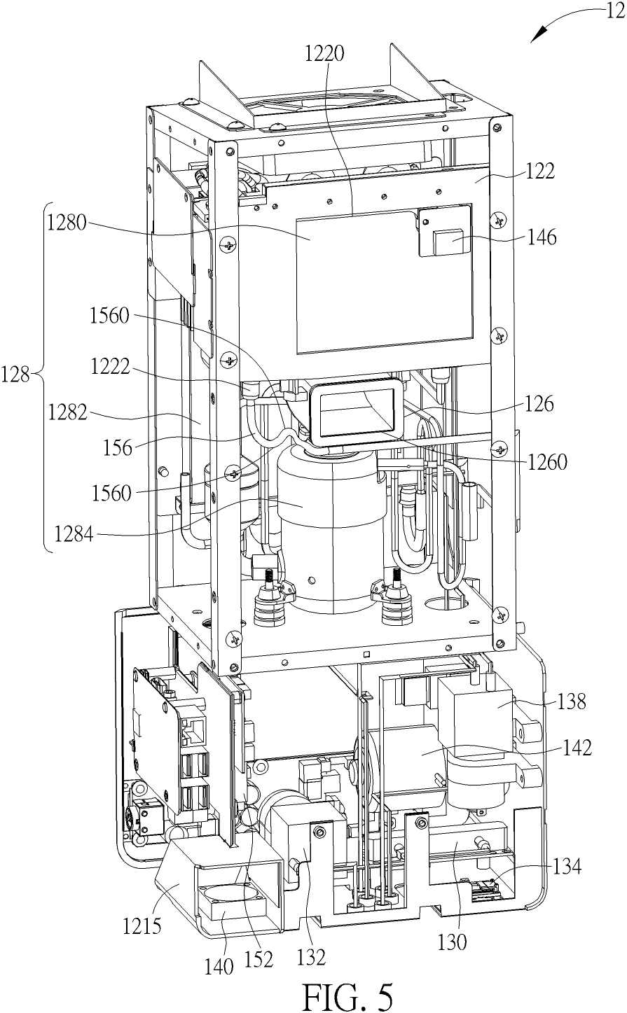

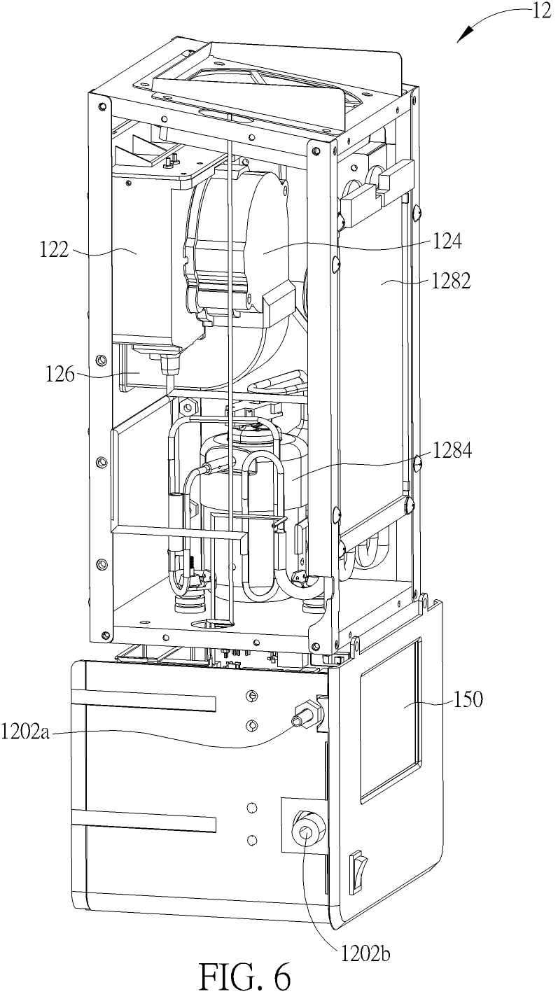

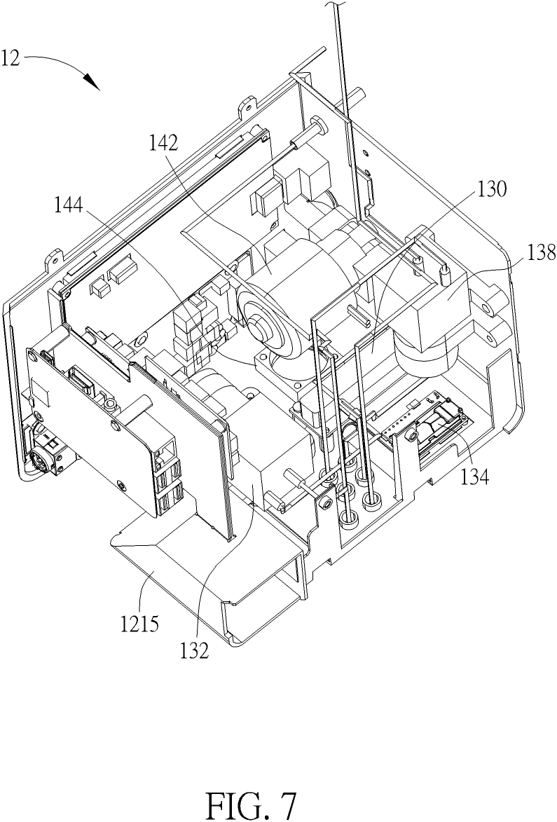

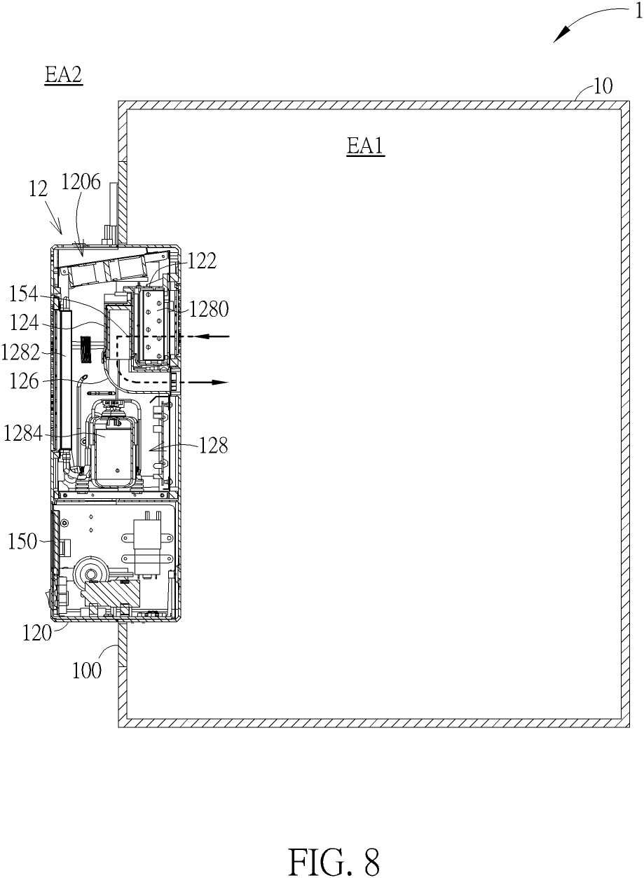

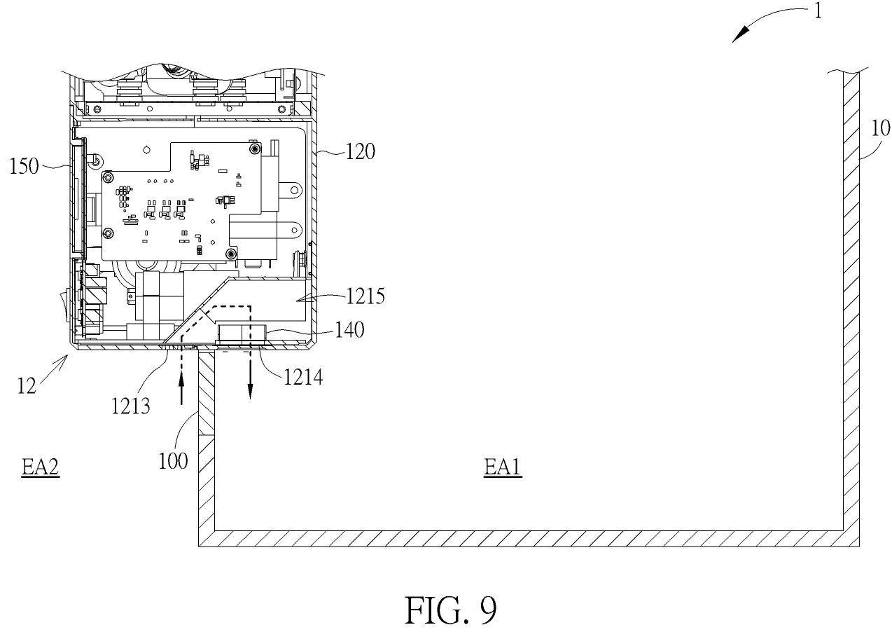

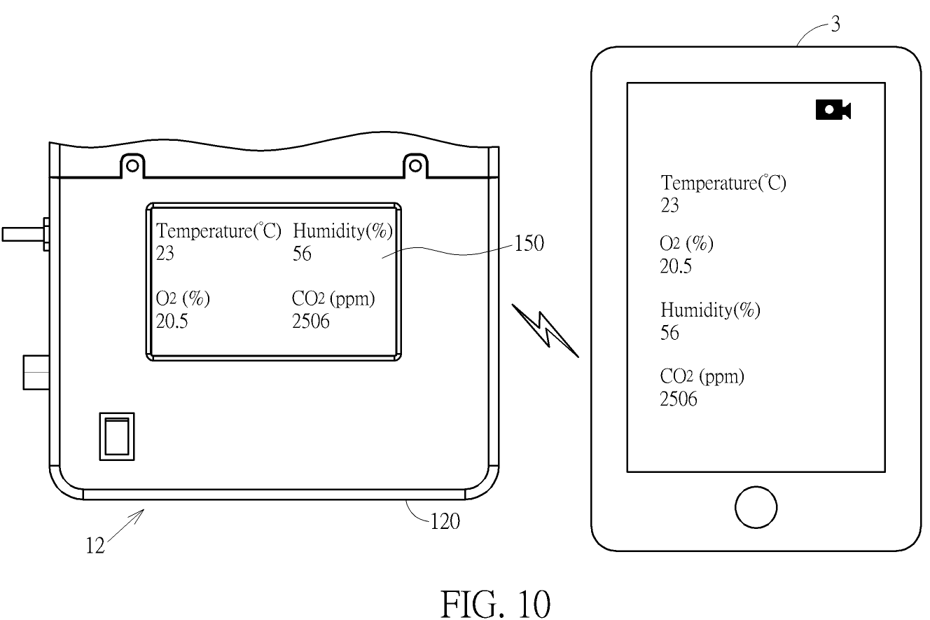

Referring to FIGS. 1 to 10, FIG. 1 is a perspective view illustrating an organism care system 1 according to an embodiment of the disclosure, FIG. 2 is a perspective view illustrating the organism care system 1 shown in FIG. 1 from another viewing angle, FIG. 3 is a perspective view illustrating the organism care system 1 shown in FIG. 1 from another viewing angle, FIG. 4 is a perspective view illustrating an air adjusting device 12 shown in FIG. 1 from another viewing angle, FIG. 5 is a perspective view illustrating the inside of the air adjusting device 12 shown in FIG. 1 from another viewing angle, FIG. 6 is a perspective view illustrating the air adjusting device 12 shown in FIG. 5 from another viewing angle, FIG. 7 is a partial perspective view illustrating the air adjusting device 12 shown in FIG. 5 from another viewing angle, FIG. 8 is a sectional view illustrating the organism care system 1 shown in FIG. 1, FIG. 9 is a partial sectional view illustrating the organism care system 1 shown in FIG. 1, and FIG. 10 is a schematic view illustrating the air adjusting device 12 shown in FIG. 1 communicating with an electronic device 3.

As shown in FIGS. 1 to 3, the organism care system 1 comprises an enclosed chamber 10 and an air adjusting device 12. The organism care system 1 may be a pet ICU or other devices for taking care of an organism according to practical applications. The enclosed chamber may a box, a cage or other chambers for accommodating an organism according to practical applications. In this embodiment, the enclosed chamber 10 may comprise a movable door 100, wherein the movable door 100 may be opened or closed by a rotating manner. Needless to say, the movable door 100 may also be opened or closed by other movable manners, so the disclosure is not limited to the rotating manner.

As shown in FIGS. 1 to 7, the air adjusting device 12 comprises a casing 120, a hood 122, a first airflow generating unit 124, a tunnel 126, an air conditioning module 128, an oxygen detector 130, a first air drawing motor 132, a carbon dioxide detector 134, a carbon dioxide absorbing box 136, a second air drawing motor 138, a second airflow generating unit 140, an electromagnetic valve 142, a third airflow generating unit 144, a temperature sensor 146, a plurality of brackets 148, a display panel 150 and a communication module 152. It should be noted that in addition to the aforesaid components, the air adjusting device 12 may be further equipped with some necessary hardware and software components for specific purposes, such as circuit board, controller, memory, power supply, applications, etc., and it depends on practical applications. Furthermore, the position of the communication module 152 shown in FIG. 5 is only for illustration purpose and the communication module 152 may be disposed at other positions within the casing 120 according to practical applications. In this embodiment, the first airflow generating unit 124, the second airflow generating unit 140 and the third airflow generating unit 144 may be, but not limited to, fans.

The casing 120 of the air adjusting device 12 is disposed on the enclosed chamber 10. In this embodiment, the casing 120 of the air adjusting device 12 may be disposed on the movable door 100 of the enclosed chamber 10, wherein parts of the casing 120 may be located inside the enclosed chamber 10 and other parts of the casing 120 may be located outside the enclosed chamber 10. In this embodiment, the movable door 100 may has an opening 1000 and the casing 120 of the air adjusting device 12 may be embedded in the opening 1000 to be disposed on the movable door 100. Preferably, the size of the opening 1000 of the movable door 100 may be substantially identical to the size of the casing 120 of the air adjusting device 12, such that the casing 120 may be tightly embedded in the opening 1000. After the casing 120 is embedded in the opening 1000, the disclosure may use a sealing glue or other sealing components to seal a gap around the casing 120 and the opening 1000, so as to prevent the inside of the enclosed chamber 10 from communicating with the outside. The fixing brackets 148 are disposed at a periphery of the casing 100 and fixed to the movable door 100 of the enclosed chamber 10, so as to dispose the air adjusting device 12 on the enclosed chamber 10. In this embodiment, there are two fixing brackets 148 disposed at opposite sides of the casing 120, but the disclosure is not so limited. In another embodiment, the casing 120 of the air adjusting device 12 may also be disposed at other positions (e.g. side wall) of the enclosed chamber 10 by the fixing brackets 148 according to practical applications. Still further, the movable door 100 may be transparent, such that a user may watch the inside condition of the enclosed chamber 10 directly through the movable door 100.

The bottom of the casing 120 has two oxygen output holes 1200a, 1200b and the two oxygen output holes 1200a, 1200b are located inside the enclosed chamber 10. In this embodiment, the two oxygen output holes 1200a, 1200b are located at a bottom surface of the casing 120. In another embodiment, the two oxygen output holes 1200a, 1200b may also be located at a side surface of the casing 120 and close to the bottom of the casing 120 or located at an appropriate position around the casing 120. In addition, the side of the casing 120 further has two oxygen input holes 1202a, 1202b and the two oxygen input hole 1202a, 1202b are located outside the enclosed chamber 10. The oxygen output hole 1200a and the oxygen input hole 1202a may communicate with each other by a pipe. Furthermore, the oxygen input hole 1202b may be provided by the electromagnetic valve 142 within the casing 120 and the oxygen output hole 1200b may communicate with the electromagnetic valve 142 by another pipe. The oxygen input holes 1202a, 1202b may be respectively connected to an oxygen generating device (e.g. oxygen generator, central oxygen system etc.). Accordingly, oxygen generated by the oxygen generating device may be output to the inside of the enclosed chamber 10 from the oxygen output holes 1200a, 1200b via the oxygen input holes 1202a, 1202b and the corresponding pipes. In another embodiment, the casing 120 may only have the oxygen output hole 1200a and the oxygen input hole 1202a or only have the oxygen output hole 1200b and the oxygen input hole 1202b according to practical applications.

The disclosure may adjust the oxygen output to the inside of the enclosed chamber 10 through the oxygen input hole 1202b and the oxygen output hole 1200b by switching on or off the electromagnetic valve 142. Furthermore, the bottom of the casing 120 has a heat dissipating hole 1204 and the heat dissipating hole 1204 is located outside the enclosed chamber 10. In this embodiment, the heat dissipating hole 1204 is located at a bottom surface of the casing 120. In another embodiment, the heat dissipating hole 1204 may also be located at a side surface of the casing 120 and close to the bottom of the casing 120 or located at an appropriate position around the casing 120. The third airflow generating unit 144 is disposed in the casing 120 with respect to the electromagnetic valve 142. The third airflow generating unit is configured to dissipate heat from the electromagnetic valve 142 and discharge the heat to the outside of the enclosed chamber 10 from the heat dissipating hole 1204.

The hood 122, the first airflow generating unit 124, the tunnel 126 and the air conditioning module 128 are disposed in the casing 120. The first airflow generating unit 124 may be, but not limited to, a turbofan. The first airflow generating unit 124 is connected to the hood 122 and the tunnel 126 is connected to the first airflow generating unit 124, such that the hood 122, the first airflow generating unit 124 and the tunnel 126 form an airflow passage 154, wherein the airflow passage 154 is isolated from an internal space 1206 of the casing 120, i.e. the airflow passage 154 does not communicate with the internal space 1206 of the casing 120. The hood 122 has a wind inlet 1220 and the tunnel 126 has a wind outlet 1260, wherein the wind inlet 1220 and the wind outlet 1260 are located inside the enclosed chamber 10. At least one part of the air conditioning module 128 is disposed at the wind inlet 1220 of the hood 122. Accordingly, the first airflow generating unit 124 can draw a first ambient air EA1 (as shown in FIG. 8) inside the enclosed chamber 10 into the airflow passage 154 from the wind inlet 1220 of the hood 122. Then, a temperature of the first ambient air EA1 will be adjusted by the air conditioning module 128 and discharged to the inside of the enclosed chamber 10 from the wind outlet 1260 of the tunnel 126 through the airflow passage 154. Thus, the disclosure can utilize the air conditioning module 128 to adjust the temperature of the first ambient air EA1 inside the enclosed chamber 10.

In this embodiment, the air conditioning module 128 may comprise an evaporator 1280, a condenser 1282 and a compressor 1284, wherein the evaporator 1280 is disposed at the wind inlet 1220 of the hood 122. The air conditioning module 128 may provide air-conditioning or heating function. When the air conditioning module 128 switches on the air-conditioning function, the temperature of the first ambient air EA1 will be cooled by the evaporator 1280 of the air conditioning module 128 and then the cooled first ambient air EA1 will be discharged to the inside of the enclosed chamber 10 from the wind outlet 1260 of the tunnel 126 through the airflow passage 154. Since the airflow passage 154 does not communicate with the internal space 1206 of the casing 120, the inside of the enclosed chamber 10 will not exchange air with the outside. Accordingly, the oxygen inside the enclosed chamber 10 can be maintained at a specific concentration, such that an organism accommodated inside the enclosed chamber 10 can be well taken care of. It should be noted that, in another embodiment, other appropriate components of the air conditioning module may also be disposed at the wind inlet 1220 of the hood 122 according to practical applications.

As shown in FIG. 5, the temperature sensor 146 is disposed at the wind inlet 1220 of the hood 122. The temperature sensor 146 is configured to sense the temperature of the first ambient air EA1 inside the enclosed chamber 10. Thus, the air conditioning module 128 may adjust the temperature of the first ambient air EA1 according to a sensing result of the temperature sensor 146. In another embodiment, the air adjusting device 12 may further comprise a humidity sensor, such that the disclosure may sense the humidity inside the enclosed chamber 10 by the humidity sensor.

In this embodiment, the hood 122 may have a water discharging hole 1222 and the air adjusting device 12 may further comprise a curved water pipe 156, wherein the curved water pipe 156 is connected to the water discharging hole 1222. The curved water pipe 156 may have a plurality of curved portions 1560, wherein the curved portions 1560 are connected to each other and curved directions of two adjacent curved portions 1560 are opposite. As shown in FIG. 5, the curved water pipe 156 has two curved portions 1560, wherein the curved direction of one curved portion 1560 is upward and the curved direction of the other curved portion 1560 is downward. Water generated during the operation of the air conditioning module 128 may be accumulated at the curved portions 1560 of the curved water pipe 156, so as to prevent the oxygen inside the enclosed chamber 10 from leaking through the water discharging hole 1222. In this embodiment, the air adjusting device 12 may further comprise a water container 158 disposed at a side of the casing 120, such that the water generated during the operation of the air conditioning module 128 may be discharged to the water container 158 through the curved water pipe 156.

As shown in FIG. 4, the bottom of the casing 120 further has a first air inlet 1208, a first air outlet 1209, a carbon dioxide sensing hole 1210, a second air inlet 1211, a second air outlet 1212, an air drawing hole 1213 and an air discharging hole 1214, wherein the first air inlet 1208, the first air outlet 1209, the carbon dioxide sensing hole 1210, the second air inlet 1211, the second air outlet 1212 and the air discharging hole 1214 are located inside the enclosed chamber 10, and the air drawing hole 1213 is located outside the enclosed chamber 10. In this embodiment, the first air inlet 1208, the first air outlet 1209, the carbon dioxide sensing hole 1210, the second air inlet 1211, the second air outlet 1212, the air drawing hole 1213 and the air discharging hole 1214 are located at a bottom surface of the casing 120. In another embodiment, the first air inlet 1208, the first air outlet 1209, the carbon dioxide sensing hole 1210, the second air inlet 1211, the second air outlet 1212, the air drawing hole 1213 and the air discharging hole 1214 may also be located at a side surface of the casing 120 and close to the bottom of the casing 120 or located at an appropriate position around the casing 120. As shown in FIGS. 5 and 9, the casing 120 may further comprise a partition 1215 and the second airflow generating unit 140 may be disposed in the partition 1215 of the casing 120, wherein the air drawing hole 1213 and the air discharging hole 1214 are located at the bottom of the partition 1215.

The oxygen detector 130 is disposed in the casing 120. The first air drawing motor 132 is disposed in the casing 120 and connected to the oxygen detector 130. In this embodiment, the first air drawing motor 132 may be respectively connected to the first air inlet 1208 and the oxygen detector 130 by two pipes, and the oxygen detector 130 may be connected to the first air outlet 1209 by another pipe. The first air drawing motor 132 is configured to draw the first ambient air EA1 inside the enclosed chamber 10 into the oxygen detector 130 from the first air inlet 1208 and discharge the first ambient air EA1 to the inside of the enclosed chamber 10 from the first air outlet 1209. The oxygen detector 130 is configured to sense an oxygen concentration of the first ambient air EA1 drawn in from the first air inlet 1208. When the oxygen concentration of the first ambient air EA1 is higher than a first predetermined value, the second airflow generating unit 140 may be switched on to draw a second ambient air EA2 outside the enclosed chamber 10 (as shown in FIG. 9) into the air drawing hole 1213 and discharge the second ambient air EA2 to the inside of the enclosed chamber 10 from the air discharging hole 1214, such that the second ambient air EA2 is mixed with the first ambient air EA1, so as to prevent excessive oxygen concentration from damaging the organism within the enclosed chamber 10. The aforesaid first predetermined value may be set according to the required oxygen concentration inside the enclosed chamber 10.

The carbon dioxide detector 134 is disposed in the casing 120 with respect to the carbon dioxide sensing hole 1210. The carbon dioxide absorbing box 136 is disposed at a side of the casing 120 and located outside the enclosed chamber 10, wherein the carbon dioxide absorbing box 136 contains soda lime (not shown) . The second air drawing motor 138 is disposed in the casing 120 and connected to the carbon dioxide absorbing box 136. In this embodiment, the second air drawing motor 138 may be respectively connected to the second air inlet 1211 and the carbon dioxide absorbing box 136 by two pipes, and the carbon dioxide absorbing box 136 may be connected to the second air outlet 1212 by another pipe. The carbon dioxide detector 134 may sense a carbon dioxide concentration of the first ambient air EA1 inside the enclosed chamber 10 through the carbon dioxide sensing hole 1210. When the carbon dioxide concentration of the first ambient air EA1 is higher than a second predetermined value, the second air drawing motor 138 may be switched on to draw the first ambient air EA1 into the carbon dioxide absorbing box 136 from the second air inlet 1211. At this time, the soda lime contained in the carbon dioxide absorbing box 136 will absorb carbon dioxide of the first ambient air EA1. Then, the first ambient air EA1 is discharged to the inside of the enclosed chamber 10 from the second air outlet 1212. Accordingly, the disclosure may utilize the soda lime contained in the carbon dioxide absorbing box 136 to reduce the carbon dioxide concentration of the first ambient air EA1, so as to prevent excessive carbon dioxide concentration from damaging the organism within the enclosed chamber 10.

Furthermore, when the carbon dioxide concentration of the first ambient air EA1 is higher than a third predetermined value, it means that the soda lime contained in the carbon dioxide absorbing box 136 cannot effectively reduce the carbon dioxide concentration of the first ambient air EA1. At this time, the second airflow generating unit 140 may be switched on to draw the second ambient air EA2 outside the enclosed chamber 10 (as shown in FIG. 9) into the air drawing hole 1213 and discharge the second ambient air EA2 to the inside of the enclosed chamber 10 from the air discharging hole 1214, such that the second ambient air EA2 is mixed with the first ambient air EA1. Accordingly, the disclosure may utilize the second ambient air EA2 to reduce the carbon dioxide concentration of the first ambient air EA1, so as to prevent excessive carbon dioxide concentration from damaging the organism within the enclosed chamber 10. The aforesaid second and third predetermined values may be set according to the allowable carbon dioxide concentration inside the enclosed chamber 10, wherein the third predetermined value is larger than the second predetermined value.

As shown in FIGS. 1 and 10, the display panel 150 is disposed on the casing 120. The display panel 150 is conjured to display at least one parameter of the first ambient air EA1 inside the enclosed chamber 10, e.g. temperature, humidity, oxygen (O₂) concentration, carbon dioxide (CO₂) concentration, and so on. In this embodiment, the display panel 150 may provide a touch function for a user to perform related operation and setting for the organism care system 1. Moreover, as shown in FIG. 5, the communication module 152 is disposed in the casing 120. The communication module 152 may communicate with an electronic device 3 (as shown in FIG. 10), such that the user may monitor the current state of the organism care system 1 through the electronic device 3 at any time. In this embodiment, the electronic device 3 may install an application corresponding to the organism care system 1. The user may perform related operation and setting for the organism care system 1 through the application. When the organism care system 1 is equipped with a camera, the user may also switch on the camera through the application to monitor the current state of the organism within the enclosed chamber 10. In practical applications, the electronic device 3 may be a tablet computer, a smart phone or other electronic devices.

As mentioned in the above, since the airflow passage formed by the hood, the first airflow generating unit and the tunnel is isolated from the internal space of the casing, the inside of the enclosed chamber equipped with the air adjusting device is isolated from the outside. That is to say, the inside of the enclosed chamber will not exchange air with the outside. Accordingly, the oxygen inside the enclosed chamber can be maintained at a specific concentration, such that an organism accommodated inside the enclosed chamber can be well taken care of. Furthermore, the disclosure may further utilize the temperature sensor, the humidity sensor, the oxygen detector and/or the carbon dioxide detector to sense the temperature, the humidity, the oxygen concentration and/or the carbon dioxide concentration inside the enclosed chamber and then performs related adjustment according to the sensing result, so as to maintain the air inside the enclosed chamber at an optimal state.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An air adjusting device comprising:
a casing;
a hood disposed in the casing, the hood having a wind inlet;
a first airflow generating unit disposed in the casing and connected to the hood;
a tunnel disposed in the casing and connected to the first airflow generating unit, the tunnel having a wind outlet, the hood, the first airflow generating unit and the tunnel forming an airflow passage, the airflow passage being isolated from an internal space of the casing; and
an air conditioning module, at least one part of the air conditioning module being disposed at the wind inlet;
wherein the first airflow generating unit draws a first ambient air into the airflow passage from the wind inlet, and a temperature of the first ambient air is adjusted by the air conditioning module and discharged from the wind outlet through the airflow passage.

2. The air adjusting device of claim 1, wherein the casing has a first air inlet and a first air outlet, the air adjusting device further comprises:
an oxygen detector disposed in the casing; and
a first air drawing motor disposed in the casing and connected to the oxygen detector, the first air drawing motor drawing the first ambient air into the oxygen detector from the first air inlet and discharging the first ambient air from the first air outlet, the oxygen detector sensing an oxygen concentration of the first ambient air.

3. The air adjusting device of claim 2, wherein the casing has an air drawing hole and an air discharging hole, the air adjusting device further comprises:
a second airflow generating unit disposed in the casing, wherein when the oxygen concentration is higher than a first predetermined value, the second airflow generating unit draws a second ambient air into the air drawing hole and discharges the second ambient air from the air discharging hole, such that the second ambient air is mixed with the first ambient air.

4. The air adjusting device of claim 1, wherein the casing has a carbon dioxide sensing hole, a second air inlet and a second air outlet, the air adjusting device further comprises:
a carbon dioxide detector disposed in the casing with respect to the carbon dioxide sensing hole, the carbon dioxide detector sensing a carbon dioxide concentration of the first ambient air;
a carbon dioxide absorbing box disposed at a side of the casing, the carbon dioxide absorbing box containing soda lime; and
a second air drawing motor disposed in the casing and connected to the carbon dioxide absorbing box, wherein when the carbon dioxide concentration is higher than a second predetermined value, the second air drawing motor draws the first ambient air into the carbon dioxide absorbing box from the second air inlet, the soda lime absorbs carbon dioxide of the first ambient air, and the first ambient air is discharged from the second air outlet.

5. The air adjusting device of claim 4, wherein the casing has an air drawing hole and an air discharging hole, the air adjusting device further comprises:
a second airflow generating unit disposed in the casing, wherein when the carbon dioxide concentration is higher than a third predetermined value, the second airflow generating unit draws a second ambient air into the air drawing hole and discharges the second ambient air from the air discharging hole, such that the second ambient air is mixed with the first ambient air.

6. The air adjusting device of claim 1, further comprising an electromagnetic valve disposed in the casing, the oxygen output hole communicating with the electromagnetic valve.

7. The air adjusting device of claim 6, wherein the casing has a heat dissipating hole, the air adjusting device further comprises:
a third airflow generating unit disposed in the casing with respect to the electromagnetic valve, the third airflow generating unit dissipating heat from the electromagnetic valve and discharging the heat from the heat dissipating hole.

8. The air adjusting device of claim 1, wherein the casing further has an oxygen output hole and an oxygen input hole connected to an oxygen generating device, and oxygen generated by the oxygen generating device is output from the oxygen output hole via the oxygen input hole.

9. The air adjusting device of claim 1, wherein the hood has a water discharging hole, the air adjusting device further comprises a curved water pipe connected to the water discharging hole, the curved water pipe has a plurality of curved portions, the curved portions are connected to each other, and curved directions of two adjacent curved portions are opposite.

10. The air adjusting device of claim 1, further comprising:
a temperature sensor disposed at the wind inlet;
a display panel disposed on the casing, the display panel displaying at least one parameter of the first ambient air; and
a communication module disposed in the casing, the communication module communicating with an electronic device.

11. An organism care system comprising:
an enclosed chamber; and
an air adjusting device comprising:
a casing disposed on the enclosed chamber;
a hood disposed in the casing, the hood having a wind inlet, the wind inlet being located inside the enclosed chamber;
a first airflow generating unit disposed in the casing and connected to the hood;
a tunnel disposed in the casing and connected to the first airflow generating unit, the tunnel having a wind outlet, the wind outlet being located inside the enclosed chamber, the hood, the first airflow generating unit and the tunnel forming an airflow passage, the airflow passage being isolated from an internal space of the casing; and
an air conditioning module, at least one part of the air conditioning module being disposed at the wind inlet;
wherein the first airflow generating unit draws a first ambient air inside the enclosed chamber into the airflow passage from the wind inlet, and a temperature of the first ambient air is adjusted by the air conditioning module and discharged to the inside of the enclosed chamber from the wind outlet through the airflow passage.

12. The organism care system of claim 11, wherein the casing has a first air inlet and a first air outlet, the first air inlet and the first air outlet are located inside the enclosed chamber, the air adjusting device further comprises:
an oxygen detector disposed in the casing; and
a first air drawing motor disposed in the casing and connected to the oxygen detector, the first air drawing motor drawing the first ambient air into the oxygen detector from the first air inlet and discharging the first ambient air to the inside of the enclosed chamber from the first air outlet, the oxygen detector sensing an oxygen concentration of the first ambient air.

13. The organism care system of claim 12, wherein the casing has an air drawing hole and an air discharging hole, the air drawing hole is located outside the enclosed chamber, the air discharging hole is located inside the enclosed chamber, the air adjusting device further comprises:
a second airflow generating unit disposed in the casing, wherein when the oxygen concentration is higher than a first predetermined value, the second airflow generating unit draws a second ambient air outside the enclosed chamber into the air drawing hole and discharges the second ambient air to the inside of the enclosed chamber from the air discharging hole, such that the second ambient air is mixed with the first ambient air.

14. The organism care system of claim 11, wherein the casing has a carbon dioxide sensing hole, a second air inlet and a second air outlet, the carbon dioxide sensing hole, the second air inlet and the second air outlet are located inside the enclosed chamber, the air adjusting device further comprises:
a carbon dioxide detector disposed in the casing with respect to the carbon dioxide sensing hole, the carbon dioxide detector sensing a carbon dioxide concentration of the first ambient air;
a carbon dioxide absorbing box disposed at a side of the casing and located outside the enclosed chamber, the carbon dioxide absorbing box containing soda lime; and
a second air drawing motor disposed in the casing and connected to the carbon dioxide absorbing box, wherein when the carbon dioxide concentration is higher than a second predetermined value, the second air drawing motor draws the first ambient air into the carbon dioxide absorbing box from the second air inlet, the soda lime absorbs carbon dioxide of the first ambient air, and the first ambient air is discharged to the inside of the enclosed chamber from the second air outlet.

15. The organism care system of claim 14, wherein the casing has an air drawing hole and an air discharging hole, the air drawing hole is located outside the enclosed chamber, the air discharging hole is located inside the enclosed chamber, the air adjusting device further comprises:
a second airflow generating unit disposed in the casing, wherein when the carbon dioxide concentration is higher than a third predetermined value, the second airflow generating unit draws a second ambient air outside the enclosed chamber into the air drawing hole and discharges the second ambient air to the inside of the enclosed chamber from the air discharging hole, such that the second ambient air is mixed with the first ambient air.

16. The organism care system of claim 11, wherein the air adjusting device further comprises an electromagnetic valve disposed in the casing, and the oxygen output hole communicates with the electromagnetic valve.

17. The organism care system of claim 16, wherein the casing has a heat dissipating hole, the heat dissipating hole is located outside the enclosed chamber, the air adjusting device further comprises:
a third airflow generating unit disposed in the casing with respect to the electromagnetic valve, the third airflow generating unit dissipating heat from the electromagnetic valve and discharging the heat to an outside of the enclosed chamber from the heat dissipating hole.

18. The organism care system of claim 11, wherein the casing further has an oxygen output hole and an oxygen input hole, the oxygen output hole is located inside the enclosed chamber, the oxygen input hole is located outside the enclosed chamber, the oxygen input hole is connected to an oxygen generating device, and oxygen generated by the oxygen generating device is output to an inside of the enclosed chamber from the oxygen output hole via the oxygen input hole.

19. The organism care system of claim 11, wherein the hood has a water discharging hole, the air adjusting device further comprises a curved water pipe connected to the water discharging hole, the curved water pipe has a plurality of curved portions, the curved portions are connected to each other, and curved directions of two adjacent curved portions are opposite.

20. The organism care system of claim 1, wherein the air adjusting device further comprises a plurality of fixing brackets disposed at a periphery of the casing and fixed to the enclosed chamber, the enclosed chamber comprises a movable door, and the casing is disposed on the movable door.
